(19) United States
(12) Patent Application Publication
(10) Pub. No.: US 2025/0240602 A1
(43) Pub. Date: Jul. 24, 2025

(54) LOCATION DETERMINATION

(71) Applicant: Nokia Solutions and Networks Oy, Espoo (FI)

(72) Inventors: Saurabh KHARE, Bangalore (IN); Mao CAI, Chengdu (CN); Shubhranshu SINGH, Munich (DE)

(21) Appl. No.: 18/833,383

(22) PCT Filed: Jan. 27, 2022
(86) PCT No.: PCT/CN2022/074359

§ 371 Date: Jul. 25, 2024

(51) Int. Cl. H04W 4/029

(52) U.S. Cl. CPC H04W 4/029

(57) ABSTRACT

Example embodiments of the present disclosure relate to methods, devices, apparatuses and computer readable storage media for location determination. In example embodiments, a first device transmits, to a second device, a first request for indoor or outdoor information of a user equipment. Moreover, the first device receives, from the second device, indoor or outdoor analytics information of the user equipment.

### FIELD

Example embodiments of the present disclosure generally relate to the field of communications, and in particular, to methods, devices, apparatuses and computer readable storage media for location determination.

### BACKGROUND

The positioning of user equipment (UE) can be supported by radio access technology (RAT) dependent position methods, which rely on for example RAT measurements obtained by a target UE and/or on measurements obtained a network device. Positioning of a UE can also be supported by RAT independent position methods which may rely on non-RAT measurements obtained by a UE and/or on other information.

In a fifth generation (5G) system (5GS), location services (LCS) for a UE may be supported by a location management function (LMF). For example, a UE may obtain location measurements and sends the location measurements to the LMF. Accordingly, the LMF may determine a location of the UE based on the location measurements obtained from the UE. The LMF may also determine the location of the UE based on the location measurements obtained from another network device without the assistance of the UE.

However, accuracy of the current location determination may not satisfy some regulations and requirements for some applications and use cases, for example, location accuracy requirements for emergency cases, and Industrial internet of things (IoT) applications, etc. Therefore, among others open issues, how to efficiently and accurately obtain location information of the UE is an open issue to be addressed.

### SUMMARY

In general, example embodiments of the present disclosure provide methods, devices, apparatuses and computer readable storage media for location determination.

In a first aspect, a method is provided. In the method, a first device transmits, to a second device, a first request for indoor or outdoor information of a user equipment. Moreover, the first device receives, from the second device, indoor or outdoor analytics information of the user equipment.

In a second aspect, a method is provided. In the method, a second device receives, from a first device, a first request for indoor or outdoor information of a user equipment. Then, the second device determines indoor or outdoor analytics information of the user equipment. Moreover, the second device transmits, to the first device, the indoor or outdoor analytics information of the user equipment.

In a third aspect, a first device is provided which comprises at least one processor and at least one memory including computer program code. The at least one memory and the computer program code are configured to, with the at least one processor, cause the first device to transmit, to a second device, a first request for indoor or outdoor information of a user equipment. Moreover, the first device is caused to receive, from the second device, indoor or outdoor analytics information of the user equipment.

In a fourth aspect, a second device is provided which comprises at least one processor and at least one memory including computer program code. The at least one memory and the computer program code are configured to, with the at least one processor, cause the second device to receive, from a first device, a first request for indoor or outdoor information of a user equipment. Then, the second device is caused to determine indoor or outdoor analytics information of the user equipment. Moreover, the second device is caused to transmit, to the first device, the indoor or outdoor analytics information of the user equipment.

In a fifth aspect, there is provided an apparatus comprising means for performing the method according to the first or second aspect.

In a sixth aspect, there is provided a computer readable storage medium comprising program instructions stored thereon. The instructions, when executed by a processor of a device, cause the device to perform the method according to the first or second aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow between the first device and the second device according to some example embodiments of the present disclosure;

FIG. 3 illustrates an example process for interactions for indoor or outdoor information according to some example embodiments of the present disclosure;

FIG. 4 illustrates an example process for determining indoor or outdoor information according to some example embodiments of the present disclosure;

FIG. 5 illustrates a flowchart of an example method according to some example embodiments of the present disclosure;

FIG. 6 illustrates a flowchart of an example method according to some other example embodiments of the present disclosure; and

FIG. 7 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “access network device” refers to a device via which services can be provided to a terminal device in a communication network. As an example, the access network device may comprise a base station. As used herein, the term “base station” (BS) refers to an access network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device”, “user device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the user device include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, in some example embodiments, the term “core network device” refers to a device capable of communicating with the access network device and providing services to the terminal device in a core network. Examples of the core network device may include user plane functions (UPFs), application servers, Mobile Switching Centers (MSCs), MMEs, Operation and Management (O&M) nodes, Operation Support System (OSS) nodes, Self-Organization Network (SON) nodes, positioning nodes such as Enhanced Serving Mobile Location Centers (E-SMLCs), Mobile Data Terminals (MDTs), a Common Control Network Function (CCNF), an Access and mobility Management Function (AMF), a Session Management Function (SMF), a Policy Control Function (PCF), a LMF, a Gateway Mobile Location Centre (GMLC) and/or a Network Data Analytics Function (NWDAF).

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

In a fifth generation system (5GS), a NWDAF may be used for data collection and data analytics in a centralized manner or for edge computing. The NWDAF may interact with other network functions service-based interfaces. The, the other network functions may use the data analytics provided by the NWDAF to improve network performance.

Beside, as discussed above, the LMF may be used to determine a location of a UE. There are some further discussions about LCS, with an aim to further improve accuracy of the location determination. Additionally, for some emergency cases, the determination of certain specific and needed information, such as indoor and outdoor location of the UE, is very important. For example, police or lawful agency or Firefighter wants to know if a victim is inside a building or outside the building, and according with the knowledge of the indoor and outdoor, they may approach the user. For example, indoor or outdoor information is mandatory for some regulations like Federal Communications Commission (FCC) “Wireless E911 Location Accuracy Requirements”, which requires ±3 meters accuracy for indoor cases.

However, currently, it is not supported to determine the indoor or outdoor information of a UE at any 5GS network function including a LMF. Besides, the NWDAF does not support analytics function related to the UE's indoor and/or outdoor status. Thus, it is not possible for any 5GS network functions to get analytics and/or prediction information related to UE's indoor and/or outdoor status from the NWDAF. Further, in 3GPP Release 18, the indoor or outdoor information have been emphasized as one of the main problem to be solved. By now, there is no effective way to determine the indoor or outdoor status of the UE.

Example embodiments of the present disclosure provide a scheme of location determination. With the scheme, a device (referred to as a first device) transmits a request for indoor or outdoor information of a user equipment to another device (referred to as a second device). Moreover, the first device receives indoor or outdoor analytics information of the user equipment from the second device.

This scheme facilitates flexible and efficient indoor or outdoor information determination by utilizing analytics information related to the UE's indoor and/or outdoor status obtained based on artificial intelligence (AI) or machine learning (ML). Additionally, knowledge of such indoor or outdoor information of the UE helps LMF to use more optimal positioning method to determine accurate indoor and/or outdoor position of the UE. As such, it is allowed to achieve more accurate location determination.

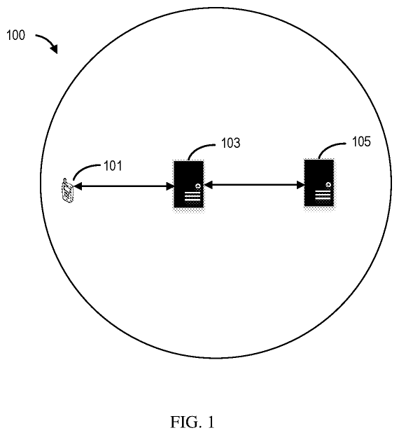

FIG. 1 shows an example environment 100 in which example embodiments of the present disclosure can be implemented.

As shown, the environment 100, which is a part of a communication network, includes a UE 101, an LMF 103 and an NWDAF 105. The communication among the UE 101, the LMF 103 and the NWDAF 105 may be direct or indirect. For example, the LMF 103 may communicate with the UE 101 via an access network device, and an AMF.

It is to be understood that the devices or functions are shown in the environment 100 only for the purpose of illustration, without suggesting any limitation. The environment 100 may include any other suitable devices, elements or functions to the scope of the present disclosure. For example, the environment 100 may further include a further device, such as, an access network device and/or a core network function or device, to assist the communication between the UE 101, the LMF 103 and the NWDAF 105.

The communication between the individual devices or functions in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (cMBB), massive machine type communication (mMTC), ultra-reliable low latency communication (URLLC), Carrier Aggregation (CA), Dual Connection (DC), and New Radio Unlicensed (NR-U) technologies. The scope of the present disclosure will not be limited in this regard.

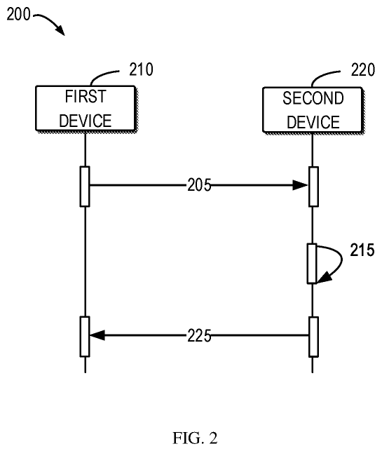

FIG. 2 shows a signaling flow 200 between the first device 210 and the second device 220 according to some example embodiments of the present disclosure. For the purpose of discussion, the signaling flow 200 will be described with reference to FIG. 1. For example, the first device 210 may be implemented by one of: a LCS client which is a consumer of the LCS, the LMF 103, an AMF, a GMLC, an application function, a network function, or a fifth generation core network function. For example, the second device 220 may be implemented by one of: a LMF 103, the NWDAF 105, a management data analytics service (MDAS) or an analytics function.

As shown in FIG. 2, the first device 210 transmits (205) a request (referred to as a first request) for indoor or outdoor information of the UE 101 to the second device 220. Accordingly, the second device 220 receives the first request for indoor or outdoor information of the UE 101 from the first device 210.

In the example embodiments where the first device 210 is implemented by the LMF 103 and the second device 220 is implemented by the NWDAF 105, a MDAS or an analytics function, if the device 210 receives another request (referred to as a second request) for indoor or outdoor information of the UE 101 from a LCS client or a network function, such as an AMF, or an access network device, it may transmit the first request for indoor or outdoor information of the UE 101 to the second device 220.

In the example embodiments where the first device 210 is implemented by the LCS client, a GMLC, or an AMF and the second device 220 is implemented by the NWDAF 105, a MDAS or an analytics function, the first device 210 may transmit directly the first request for indoor or outdoor information of the UE 101 to the second device 220. Accordingly, the indoor or outdoor analytics information of the UE 101 may be returned back directly to the first device 210.

Then, the second device 220 determines (215) the indoor or outdoor analytics information of the UE 101, after receiving the first request for indoor or outdoor information of the UE 101 from the first device 210.

In some example embodiments, the second device 220 may subscribes to different network functions, such as an application function (AF) or an Analytics Data Repository Function (ARDF) to obtain relevant information in order to determine the requested the indoor or outdoor analytics information of the UE 101. For example, the obtained relevant information may be shown in Table 1.

TABLE 1
obtained relevant information

| Information | Source | Description |
|---|---|---|
| UE ID (input data) | | SUPI |
| UE location determine | LCS(LMF/GMLC) | UE positions |
| by LCS | | |
| UE location | | Coordinates or location defined by LCS services |
| Timestamp | | timestamp |
| User images | CRM/AF | User images who is using the UE. |
| | | These images can be provided by CRM or AF |
| | | (police agency) |
| Area/Building layout | AF | Area map, building 3G model of the area of LCS |
| | | determined the location |
| Historical data of the | Analytics Data | To find out user behavior or previous movement |
| user | Repository | pattern |
| | Function | |
| | (ADRF)/NWDAF | |
| Camera feeds | AF | A video stream (CCTV) on the nearby areas to find |
| | | if user is available there or not. |
| WIFI Details/SID | AF | Wifi details/SID of the building where user may be |
| | | located |
| UE IP address | SMF | UE IP address allocated by 3GPP or Wifi, then use |
| | | it to determine if user is accessing which services |
| | | on which access point (example, attached to wifi) |
| List of Neighbouring | AMF/NWDAF | A list of UE sharing same cell, WiFi AP; detected |
| UE | | same Bluetooth device, etc., or have common |
| | | subscription (family plan) |
| global navigation | LMF | GNSS satellite visibility patterns |
| satellite system | | |
| (GNSS) measurements | | |
| radio access | LMF | Measurements of timing, signal strength and angle, |
| technology (RAT) | | such as Angle of Arrival (AoA) and Angle of |
| measurements | | Departure (AoD) |

Then, in some example embodiments, the device 220 may determine the indoor or outdoor analytics information of the UE 101 based on AI or ML and additionally based on at least one of: an image associated with the UE 101, a video stream from outside and/or inside a building near the UE 101, layout or geographical map of the building or area, historical data associated with previous movement of the UE 101, wireless fidelity information associated with the UE 101, GNSS measurements of the UE 101, RAT measurements of the UE 101, or a list of neighboring UEs.

In the example embodiments where the device 220 may determine the indoor or outdoor analytics information of the UE 101 based on the GNSS measurements of the UE 101, the device 220 may determine the indoor or outdoor analytics information of the UE 101 based on the GNSS satellite visibility patterns. In this case, for each building or house, it has relatively fixed orientations. The UE 101 inside the building/house may show certain pattern of satellite visibility. For example, when the UE 101 has visibility of satellite of various directions, it may be most likely that the UE 101 is outdoors, otherwise, the UE 101 is indoors. Then, based on the location and time, the device 220 may learn the orientation or satellite visibility pattern based on AI/ML. On this basis, when the satellite visibility pattern of the UE 101 matches a certain learnt pattern, the UE the device 220 may determine that the UE 101 should be indoors or outdoors.

In the example embodiments where the device 220 may determine the indoor or outdoor analytics information of the UE 101 based on RAT measurements of the UE 101, the device 220 may determine the indoor or outdoor analytics information of the UE 101 based on measurements of timing, signal strength and angle, such as AoA and AoD. In this case, for example, a RAT heatmap and fingerprint of the area may be provisioned beforehand. Then, the RAT measurements may be reported to the device 220 to determine indoor and outdoor analytics information.

In the example embodiments where the device 220 may determine the indoor or outdoor analytics information of the UE 101 based on a list of neighboring UEs, the second device 220 may obtain UE aggregation patterns, for example, historical data based neighboring UEs. For example, family numbers usually stays indoors together during night time. As another example, co-workers usually stay together during working hours, sharing similar indoor/outdoor attributes. Then, based on information of this list of neighboring UEs, such as location information or an indoor or outdoor status of one member of the list, the device 220 may determine the indoor or outdoor analytics information of the UE 101, if it is determined that the UE 101 is a member of the list of neighboring UEs.

In some example embodiments, the indoor or outdoor analytics information of the user equipment comprises: mobility statistics of the UE 101 which includes at least one of an indoor or outdoor indication, coordinates of the building. For example, the indoor or outdoor analytics information of the user equipment may be shown in Table 2.

TABLE 2
mobility statistics

| Information | Description |
|---|---|
| UE group ID or UE ID | Identifies a UE or a group of UEs, |
| Time slot entry (1 . . . max) | List of time slots during the |
| | Analytics target period |
| Time slot start | Time slot start within the |
| | Analytics target period |
| Duration | Duration of the time slot |
| IndoorIndication | Indoor indication |
| area coordinates | Coordinates of the building |

In some example embodiments, the indoor or outdoor analytics information of the user equipment comprises: mobility prediction of the UE 101 which includes at least one of an indoor or outdoor indication, coordinates of the building, confidence level of the prediction. For example, the indoor or outdoor analytics information of the user equipment may be shown in Table 3.

TABLE 3
mobility predictions

| Information | Description |
|---|---|
| UE group ID or UE ID | Identifies a UE or a group of UEs |
| Time slot entry (1 . . . max) | List of predicted time slots |
| Time slot start | Time slot start time within the |
| | Analytics target period |
| Duration | Duration of the time slot |
| IndoorIndication | Indoor indication |
| area coordinates | Coordinates of the building |
| Confidence | Confidence of this prediction |

As shown in FIG. 2, the second device 220 transmits (225), to the first device 210, the indoor or outdoor analytics information of the UE 101. Accordingly, the first device 210 receives the indoor or outdoor analytics information of the UE 101.

In the example embodiments where the first device 210 is implemented by the LMF 103 and the second device 220 is implemented by the NWDAF 105, a MDAS or an analytics function, as a response to the second request for indoor or outdoor information of the UE 101 from the LCS client or the network function, the first device 210 may transmit the indoor or outdoor analytics information of the UE 101 towards the LCS client or to the network function, after receiving the indoor or outdoor analytics information of the UE 101 from the device 220. Further, the device 210 may use the indoor or outdoor analytics information to better determine positioning method optimized to indoor positioning or outdoor positioning. Then, the device 210 may determine a location of the UE 101 based on the indoor or outdoor analytics information of the UE 101. For example, the device 210 may transmit the location of the UE 101 and the indoor or outdoor analytics information of the UE 101 together towards the LCS client or to the network function, if the LCS client or the network function requests the location information. Alternatively, if the second device 220 may not able to provide the indoor or outdoor analytics information of the UE 101 within an expected response time period for the first device 210 as a response to the first device 210, the second device 220 may provide the indoor or outdoor analytics information of the UE 101 in a subsequent response. Then, the first device 210 may include the indoor or outdoor analytics information of the UE 101 in the subsequent notification of the location information determined by the first device 210. Further, the first device 210 may also include the confidence of the predicted indoor or outdoor analytics information.

In the example embodiments where the first device 210 is implemented by an AMF and the second device 220 is implemented by the LMF 103, the first device 210 may transmit the indoor or outdoor analytics information of the UE 101 to a GMLC. In this case, alternatively, the indoor or outdoor analytics information of the UE 101 may be determined by the NWDAF 105, and transmitted by the NWDAF 105 to the LMF 103. For example, the GMLC may further transmit the indoor or outdoor analytics information of the UE 101 to the LCS Client, where LCS client may be Location Services consumer.

In the example embodiments where the first device 210 is implemented by a GMLC and the second device 220 is implemented by the LMF 103, the first device 210 may transmit the indoor or outdoor analytics information of the UE 101 to the LCS client. In this case, alternatively, the indoor or outdoor analytics information of the UE 101 may be determined by the NWDAF 105, and transmitted by the NWDAF 105 to the LMF 103.

In some example embodiments, the first device 210 may comprise a LMF, an application function or a network function. Alternatively, the second device 220 may comprise the NWDAF 105, a MDAS or an analytics function. Alternatively, the first device 210 may comprise a 5G core network function, and the second device 220 may comprise the NWDAF 105, a MDAS or an analytics function.

Alternatively, the LCS client, the LMF 103, an AMF, a GMLC, an application function, a network function, or a fifth generation core network function may be enhanced to determine the indoor or outdoor analytics information of the UE 101.

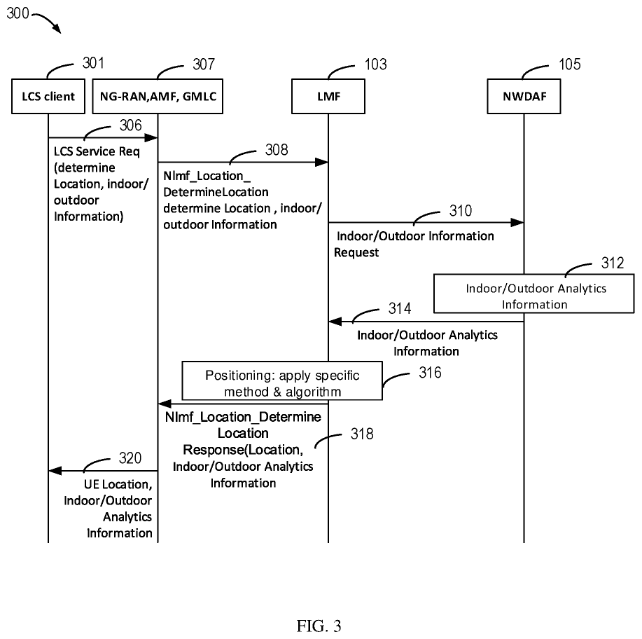

FIG. 3 illustrates an example process 300 for determining indoor or outdoor information according to some example embodiments of the present disclosure. For the purpose of discussion, the process 300 will be described with reference to FIG. 1. For example, the device 307 may be implemented by a NG-RAN device, an AMF or a GMLC, or a combination of them.

As shown in FIG. 3, at 306, the LCS client 301 transmits a LCS service request to the device 307 to determine a location of the UE 101 and indoor or outdoor information of the UE 101. Then, at 308, the device 307 transmits the location request to the LMF 103 using the Nlmf_Location_DetermineLocation with requested parameters of location information and indoor or outdoor information. At 310, the LMF 103 transmits a request for the indoor or outdoor information of the UE 101 to the NWDAF 105. At 312, the NWDAF 105 implements any new analytics determination logic to determine the indoor or outdoor analytics information of the UE 101 using any approaches described above with reference to FIG. 2.

Then, at 314, the NWDAF 105 transmits the indoor or outdoor analytics information of the UE 101 to the LMF 103. At 316, the LMF 103 uses the received indoor or outdoor analytics information of the UE 101 to determine appropriate positioning method or algorithm, for example, optimized to indoor positioning or outdoor positioning, to determine the precise location of the UE 101. Further, at 318, the LMF 103 transmits to the device 307 the location of the UE 101 and the indoor or outdoor analytics information of the UE 101 using the Nlmf_Location_Determine Location Response. Further, at 320, the device 307 transmits to the LCS client 301 the location of the UE 101 and the indoor or outdoor analytics information of the UE 101.

All operations and features as described above with reference to FIGS. 1-2 are likewise applicable to the process 300 and have similar effects. For the purpose of simplification, the details will be omitted.

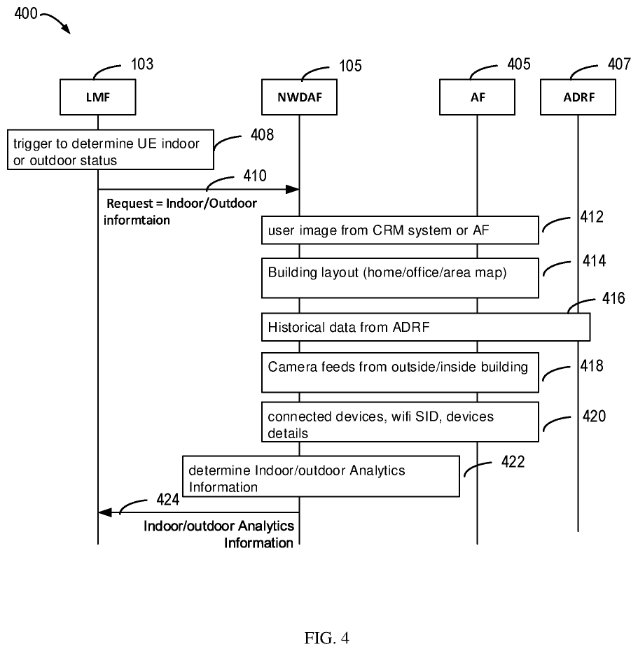

FIG. 4 illustrates an example process 400 for interactions for indoor or outdoor information according to some example embodiments of the present disclosure. For the purpose of discussion, the process 400 will be described with reference to FIG. 1. For example, The NWDAF 105 interacts with the AF 405 and the ADRF 407.

As shown in FIG. 4, at 408, the LMF 103 or any 5G Core Network Function may trigger to determine UE indoor or outdoor status. For example, the LMF 103 may receive a request for the indoor or outdoor information from a LCS client or a network function, such as such as an AMF, or an access network device, and then the LMF 103 may trigger to determine the UE indoor or outdoor status. At 410, the LMF 103 transmits a request for the indoor or outdoor information to the NWDAF 105.

At 412-420, the NWDAF 105 obtains information related to the UE indoor or outdoor status from the AF 405 or the ADRF 407. For example, the obtains information may comprise an image associated with the UE, a video stream from outside and/or inside a building near the UE, building layout, historical data associated with previous movement of the UE 101, wireless fidelity information associated with the UE. Then, at 422, the NWDAF 105 determines the indoor or outdoor analytics information based on the obtained information from the AF 405 and the ADRF 407. At 424, the NWDAF 105 transmits the indoor or outdoor analytics information to the LMF 103.

All operations and features as described above with reference to FIGS. 1-3 are likewise applicable to the process 400 and have similar effects. For the purpose of simplification, the details will be omitted.

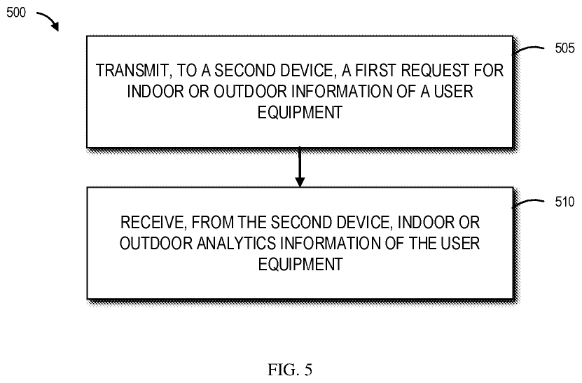

FIG. 5 shows a flowchart of an example method 500 according to some example embodiments of the present disclosure. The method 500 can be implemented at the first device 210 as shown in FIG. 2. For the purpose of discussion, the method 500 will be described with reference to FIG. 2.

At block 505, the first device 210 transmits, to the second device 220, a first request for indoor or outdoor information of a user equipment. At block 510, the first device 210 receives, from the second device 220, indoor or outdoor analytics information of the user equipment.

In some example embodiments, the first device 210 may comprise a location management function, and the second device 220 may comprise a network data analytics function, a management data analytics service or an analytics function.

In some example embodiments, the first device 210 may, in response to receiving, from a location services client or a network function, a second request for indoor or outdoor information of the user equipment, transmit, to the second device 220, the first request for indoor or outdoor information of the user equipment.

In some example embodiments, the first device 210 may transmit the indoor or outdoor analytics information of the user equipment towards the location services client or to the network function.

In some example embodiments, the first device 210 may determine, based on the indoor or outdoor analytics information of the user equipment, a location of the user equipment.

In some example embodiments, the first device 210 may comprise an access and mobility management function, and the second device 220 may comprise a location management function.

In some example embodiments, the first device 210 may transmit, to a gateway mobile location center, the indoor or outdoor analytics information of the user equipment.

In some example embodiments, the first device 210 may comprise a gateway mobile location center, and the second device 220 may comprise a location management function.

In some example embodiments, the first device 210 may transmit, to a location services client, the indoor or outdoor analytics information of the user equipment.

In some example embodiments, the indoor or outdoor analytics information of the user equipment may comprise: mobility prediction of the user equipment which includes at least one of an indoor or outdoor indication, coordinates of the building, confidence level of the prediction.

In some example embodiments, the indoor or outdoor analytics information of the user equipment may comprise: mobility statistics of the user equipment which includes at least one of an indoor or outdoor indication, coordinates of the building.

In some example embodiments, the first device 210 may comprise a location management function, an application function or a network function.

In some example embodiments, the second device 220 may comprise a network data analytics function, a management data analytics service or an analytics function.

In some example embodiments, the first device 210 may comprise a fifth generation core network function, and the second device 220 may comprise a network data analytics function, a management data analytics service or an analytics function.

Those skilled in the art can understand that all operations and features as described above with reference to FIGS. 1-4 are likewise applicable to the method 500 and have similar effects.

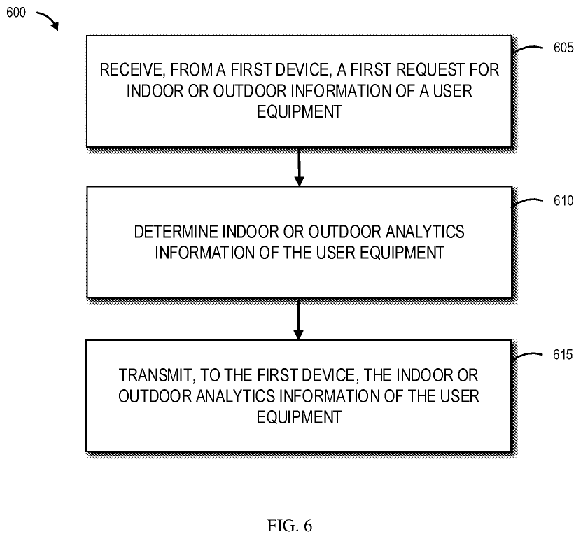

FIG. 6 shows a flowchart of an example method 600 according to some other example embodiments of the present disclosure. The method 600 can be implemented at the second device 220 as shown in FIG. 2. For the purpose of discussion, the method 600 will be described with reference to FIG. 2.

At block 605, the second device 220 receives, from the first device 210, a first request for indoor or outdoor information of a user equipment. At block 610, the second device 220 determines indoor or outdoor analytics information of the user equipment. At block 615, the second device 220 transmits, to the first device 210, the indoor or outdoor analytics information of the user equipment.

In some example embodiments, the second device 220 may determine the indoor or outdoor analytics information of the user equipment based on at least one of: an image associated with the user equipment, a video stream from outside and/or inside a building near the user equipment, layout or geographical map of the building or area, historical data associated with previous movement of the user equipment, wireless fidelity information associated with the user equipment, global navigation satellite system measurements of the user equipment, radio access technology measurements of the user equipment, or a list of neighboring user equipment.

In some example embodiments, the indoor or outdoor analytics information of the user equipment may comprise: mobility prediction of the user equipment which includes at least one of an indoor or outdoor indication, coordinates of the building, confidence level of the prediction.

In some example embodiments, the indoor or outdoor analytics information of the user equipment may comprise: mobility statistics of the user equipment which includes at least one of an indoor or outdoor indication, coordinates of the building.

In some example embodiments, the first device 210 may comprise a location management function, an application function or a network function.

In some example embodiments, the second device 220 may comprise a network data analytics function, a management data analytics service or an analytics function.

In some example embodiments, the first device 210 may comprise a fifth generation core network function, and the second device 220 may comprise a network data analytics function, a management data analytics service or an analytics function.

Those skilled in the art can understand that all operations and features as described above with reference to FIGS. 1-5 are likewise applicable to the method 600 and have similar effects.

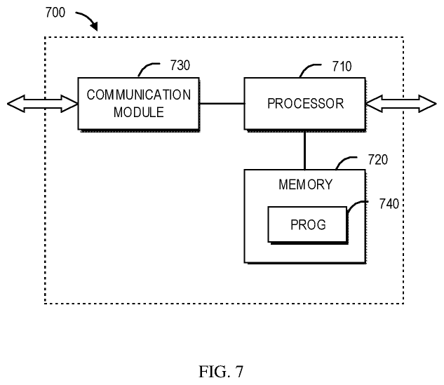

FIG. 7 is a simplified block diagram of a device 700 that is suitable for implementing example embodiments of the present disclosure. The device 700 can be implemented at or as a part of the first device 210 or the second device 220 as shown in FIG. 2.

As shown, the device 700 includes a processor 710, a memory 720 coupled to the processor 710, a communication module 730 coupled to the processor 710, and a communication interface (not shown) coupled to the communication module 730. The memory 720 stores at least a program 740. The communication module 730 is for bidirectional communications, for example, via multiple antennas. The communication interface may represent any interface that is necessary for communication.

The program 740 is assumed to include program instructions that, when executed by the associated processor 710, enable the device 700 to operate in accordance with the example embodiments of the present disclosure, as discussed herein with reference to FIGS. 1-6. The example embodiments herein may be implemented by computer software executable by the processor 710 of the device 700, or by hardware, or by a combination of software and hardware. The processor 710 may be configured to implement various example embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

When the device 700 acts as the first device 210 or a part of the first device 210, the processor 710 and the communication module 730 may cooperate to implement the method 500 as described above with reference to FIG. 2. When the device 700 acts as the second device 220 or a part of the second device 220, the processor 710 and the communication module 730 may cooperate to implement the method 600 as described above with reference to FIG. 2. All operations and features as described above with reference to FIGS. 1-6 are likewise applicable to the device 700 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIG. 2. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first device, transmitting, to a second device, a first request for indoor or outdoor information of a user equipment; and receiving, from the second device, indoor or outdoor analytics information of the user equipment.

In some example embodiments, the first device comprises a location management function, and the second device comprises a network data analytics function, a management data analytics service or an analytics function.

In some example embodiments, transmitting the request for indoor or outdoor information of the user equipment comprises: in response to receiving, from a location services client or a network function, a second request for indoor or outdoor information of the user equipment, transmitting, to the second device, the first request for indoor or outdoor information of the user equipment.

In some example embodiments, the method further comprises: transmitting the indoor or outdoor analytics information of the user equipment towards the location services client or to the network function.

In some example embodiments, the method further comprises: determining, by the first device, based on the indoor or outdoor analytics information of the user equipment, a location of the user equipment.

In some example embodiments, the first device comprises an access and mobility management function, and the second device comprises a location management function.

In some example embodiments, the method further comprises: transmitting, to a gateway mobile location center, the indoor or outdoor analytics information of the user equipment.

In some example embodiments, the first device comprises a gateway mobile location center, and the second device comprises a location management function.

In some example embodiments, the method further comprises: transmitting, to a location services client, the indoor or outdoor analytics information of the user equipment.

In some example embodiments, the indoor or outdoor analytics information of the user equipment comprises: mobility prediction of the user equipment which includes at least one of an indoor or outdoor indication, coordinates of the building, confidence level of the prediction.

In some example embodiments, the indoor or outdoor analytics information of the user equipment comprises: mobility statistics of the user equipment which includes at least one of an indoor or outdoor indication, coordinates of the building.

In some example embodiments, the first device comprises a location management function, an application function or a network function.

In some example embodiments, the second device comprises a network data analytics function, a management data analytics service or an analytics function.

In some example embodiments, the first device comprises a fifth generation core network function, and the second device comprises a network data analytics function, a management data analytics service or an analytics function.

In some aspects, a method comprises: at a second device, receiving, from a first device, a first request for indoor or outdoor information of a user equipment; determining indoor or outdoor analytics information of the user equipment; and transmitting, to the first device, the indoor or outdoor analytics information of the user equipment.

In some example embodiments, determining the indoor or outdoor analytics information of the user equipment comprises: determining the indoor or outdoor analytics information of the user equipment based on at least one of: an image associated with the user equipment, a video stream from outside and/or inside a building near the user equipment, layout or geographical map of the building or area, historical data associated with previous movement of the user equipment, wireless fidelity information associated with the user equipment, global navigation satellite system measurements of the user equipment, radio access technology measurements of the user equipment, or a list of neighboring user equipment.

In some example embodiments, the indoor or outdoor analytics information of the user equipment comprises: mobility prediction of the user equipment which includes at least one of an indoor or outdoor indication, coordinates of the building, confidence level of the prediction.

In some example embodiments, the indoor or outdoor analytics information of the user equipment comprises: mobility statistics of the user equipment which includes at least one of an indoor or outdoor indication, coordinates of the building.

In some example embodiments, the first device comprises a location management function, an application function or a network function.

In some example embodiments, the second device comprises a network data analytics function, a management data analytics service or an analytics function.

In some example embodiments, the first device comprises a fifth generation core network function, and the second device comprises a network data analytics function, a management data analytics service or an analytics function.

In some aspects, a first device, comprises: at least one processor; and at least one memory including computer program code; the at least one memory and the computer program code configured to, with the at least one processor, cause the first device to: transmit, to a second device, a first request for indoor or outdoor information of a user equipment; and receive, from the second device, indoor or outdoor analytics information of the user equipment.

In some example embodiments, the first device comprises a location management function, and the second device comprises a network data analytics function, a management data analytics service or an analytics function.

In some example embodiments, the first device is caused to transmit the request for indoor or outdoor information of the user equipment by: in response to receiving, from a location services client or a network function, a second request for indoor or outdoor information of the user equipment, transmitting, to the second device, the first request for indoor or outdoor information of the user equipment.

In some example embodiments, the first device is further caused to: transmit the indoor or outdoor analytics information of the user equipment towards the location services client or to the network function.

In some example embodiments, the first device is further caused to: determine, by the first device, based on the indoor or outdoor analytics information of the user equipment, a location of the user equipment.

In some example embodiments, the first device comprises an access and mobility management function, and the second device comprises a location management function.

In some example embodiments, the first device is further caused to: transmit, to a gateway mobile location center, the indoor or outdoor analytics information of the user equipment.

In some example embodiments, the first device comprises a gateway mobile location center, and the second device comprises a location management function.

In some example embodiments, first device is further caused to: transmit, to a location services client, the indoor or outdoor analytics information of the user equipment.

In some example embodiments, the indoor or outdoor analytics information of the user equipment comprises: mobility prediction of the user equipment which includes at least one of an indoor or outdoor indication, coordinates of the building, confidence level of the prediction.

In some example embodiments, the indoor or outdoor analytics information of the user equipment comprises: mobility statistics of the user equipment which includes at least one of an indoor or outdoor indication, coordinates of the building.

In some example embodiments, the first device comprises a location management function, an application function or a network function.

In some example embodiments, the second device comprises a network data analytics function, a management data analytics service or an analytics function.

In some example embodiments, the first device comprises a fifth generation core network function, and the second device comprises a network data analytics function, a management data analytics service or an analytics function.

In some aspects, a second device, comprising: at least one processor; and at least one memory including computer program code; the at least one memory and the computer program code configured to, with the at least one processor, cause the second device to: receive, from a first device, a first request for indoor or outdoor information of a user equipment; determine indoor or outdoor analytics information of the user equipment; and transmit, to the first device, the indoor or outdoor analytics information of the user equipment.

In some example embodiments, the second device is caused to determine the indoor or outdoor analytics information of the user equipment by: determining the indoor or outdoor analytics information of the user equipment based on at least one of: an image associated with the user equipment, a video stream from outside and/or inside a building near the user equipment, layout or geographical map of the building or area, historical data associated with previous movement of the user equipment, wireless fidelity information associated with the user equipment, global navigation satellite system measurements of the user equipment, radio access technology measurements of the user equipment, or a list of neighboring user equipment.

In some example embodiments, the indoor or outdoor analytics information of the user equipment comprises: mobility prediction of the user equipment which includes at least one of an indoor or outdoor indication, coordinates of the building, confidence level of the prediction.

In some example embodiments, the indoor or outdoor analytics information of the user equipment comprises: mobility statistics of the user equipment which includes at least one of an indoor or outdoor indication, coordinates of the building.

In some example embodiments, wherein the first device comprises a location management function, an application function or a network function.

In some example embodiments, the second device comprises a network data analytics function, a management data analytics service or an analytics function.

In some example embodiments, the first device comprises a fifth generation core network function, and the second device comprises a network data analytics function, a management data analytics service or an analytics function.

In some aspects, an apparatus comprises: means for transmitting, to a second device, a first request for indoor or outdoor information of a user equipment; and means for receiving, from the second device, indoor or outdoor analytics information of the user equipment.

In some example embodiments, the first device comprises a location management function, and the second device comprises a network data analytics function, a management data analytics service or an analytics function.

In some example embodiments, the means for transmitting the request for indoor or outdoor information of the user equipment comprises: means for, in response to receiving, from a location services client or a network function, a second request for indoor or outdoor information of the user equipment, transmitting, to the second device, the first request for indoor or outdoor information of the user equipment.

In some example embodiments, the apparatus further comprises: means for transmitting the indoor or outdoor analytics information of the user equipment towards the location services client or to the network function.

In some example embodiments, the apparatus further comprises: means for determining, by the first device, based on the indoor or outdoor analytics information of the user equipment, a location of the user equipment.

In some example embodiments, the first device comprises an access and mobility management function, and the second device comprises a location management function.

In some example embodiments, the apparatus further comprises: means for transmitting, to a gateway mobile location center, the indoor or outdoor analytics information of the user equipment.

In some example embodiments, the first device comprises a gateway mobile location center, and the second device comprises a location management function.

In some example embodiments, the apparatus further comprises: means for transmitting, to a location services client, the indoor or outdoor analytics information of the user equipment.

In some example embodiments, the indoor or outdoor analytics information of the user equipment comprises: mobility prediction of the user equipment which includes at least one of an indoor or outdoor indication, coordinates of the building, confidence level of the prediction.

In some example embodiments, the indoor or outdoor analytics information of the user equipment comprises: mobility statistics of the user equipment which includes at least one of an indoor or outdoor indication, coordinates of the building.

In some example embodiments, the first device comprises a location management function, an application function or a network function.

In some example embodiments, the second device comprises a network data analytics function, a management data analytics service or an analytics function.

In some example embodiments, the first device comprises a fifth generation core network function, and the second device comprises a network data analytics function, a management data analytics service or an analytics function.

In some aspects, an apparatus comprises: means for receiving, from a first device, a first request for indoor or outdoor information of a user equipment; means for determining indoor or outdoor analytics information of the user equipment; and means for transmitting, to the first device, the indoor or outdoor analytics information of the user equipment.

In some example embodiments, the means for determining the indoor or outdoor analytics information of the user equipment comprises: means for determining the indoor or outdoor analytics information of the user equipment based on at least one of: an image associated with the user equipment, a video stream from outside and/or inside a building near the user equipment, layout or geographical map of the building or area, historical data associated with previous movement of the user equipment, wireless fidelity information associated with the user equipment, global navigation satellite system measurements of the user equipment, radio access technology measurements of the user equipment, or a list of neighboring user equipment.

In some example embodiments, the indoor or outdoor analytics information of the user equipment comprises: mobility prediction of the user equipment which includes at least one of an indoor or outdoor indication, coordinates of the building, confidence level of the prediction.

In some example embodiments, the indoor or outdoor analytics information of the user equipment comprises: mobility statistics of the user equipment which includes at least one of an indoor or outdoor indication, coordinates of the building.

In some example embodiments, the first device comprises a location management function, an application function or a network function.

In some example embodiments, the second device comprises a network data analytics function, a management data analytics service or an analytics function.

In some example embodiments, the first device comprises a fifth generation core network function, and the second device comprises a network data analytics function, a management data analytics service or an analytics function.

In some aspects, a computer readable storage medium comprises program instructions stored thereon, the instructions, when executed by a processor of a device, causing the device to perform the method according to some example embodiments of the present disclosure.

1. A method comprising:
transmitting, by a first device to a second device, a first request for indoor or outdoor analytics information of a user equipment; and
receiving, by the first device from the second device, indoor or outdoor analytics information of the user equipment, wherein the indoor or outdoor analytics information of the user equipment comprises at least one of:
a mobility prediction of the user equipment, the mobility predicting including at least one of: an indoor or outdoor indication; coordinates of a building; or a confidence level of the mobility prediction; or
mobility statistics of the user equipment, the mobility statistics including at least one of an indoor or outdoor indication; or coordinates of a building.

2. The method of claim 1, wherein the first request is transmitted by a location management function of the first device to a network data analytics function of the second device, and the indoor or outdoor analytics information is received from the network data analytics function of the second device.

3. The method of claim 2, wherein transmitting the request for indoor or outdoor information of the user equipment comprises:
in response to receiving, from a location services client or a network function, a second request for indoor or outdoor information of the user equipment, transmitting, to the second device, the first request for indoor or outdoor information of the user equipment.

4. The method of claim 3, further comprising:
transmitting the indoor or outdoor analytics information of the user equipment towards the location services client or to the network function.

5. The method of claim 1, further comprising:
determining, by the first device, based on the indoor or outdoor analytics information of the user equipment, a location of the user equipment.

6-21. (canceled)

22. A first device for a communication network, comprising:
at least one processor; and
at least one memory including computer program code
which, when executed by the at least one processor, cause the first device to perform operations, the operations comprising:
transmitting, to a second device, a first request for indoor or outdoor analytics information of a user equipment; and
receiving from the second device, indoor or outdoor analytics information of the user equipment, wherein the indoor or outdoor analytics information of the user equipment comprises at least one of:
a mobility prediction of the user equipment, the mobility predicting including at least one of: an indoor or outdoor indication; coordinates of a building; or a confidence level of the mobility prediction; or
mobility statistics of the user equipment, the mobility statistics including at least one of an indoor or outdoor indication; or coordinates of a building.

23. The first device of claim 22, wherein the computer program code comprises computer program of a location management function, wherein the first request is transmitted by the location management function of the first device to a network data analytics function of the second device and wherein the indoor or outdoor analytics information of the user equipment is received from the network data analytics function of the second device.

24. The first device of claim 23, wherein the transmitting comprises:
in response to receiving, from a location services client or a network function of the communication network, a second request for indoor or outdoor information of the user equipment, transmitting, to the second device, the first request for indoor or outdoor information of the user equipment.

25. The first device of claim 24, wherein the operations further comprise:
transmitting the indoor or outdoor analytics information of the user equipment received from the second device towards the location services client or to the network function.

26. The first device of claim 22, wherein the operations further comprise:
determining based on the indoor or outdoor analytics information of the user equipment, a location of the user equipment.

27-35. (canceled)

36. A second device, comprising:
at least one processor; and
at least one memory including computer program code;
which, when executed by the at least one processor, cause the second device to perform operations, the operations comprising:
receiving, from a first device, a first request for indoor or outdoor analytics information of a user equipment;
determining the indoor or outdoor analytics information of the user equipment, wherein the indoor or outdoor analytics information of the user equipment comprises:
a mobility prediction of the user equipment, the mobility predicting including at least one of: an indoor or outdoor indication; coordinates of a building; or a confidence level of the mobility prediction; or
mobility statistics of the user equipment, the mobility statistics including at least one of an indoor or outdoor indication; or coordinates of a building; and
transmitting, to the first device, the indoor or outdoor analytics information of the user equipment.

37. The second device of claim 36, wherein the determining comprises:
determining the indoor or outdoor analytics information of the user equipment based on at least one of: an image associated with the user equipment, a video stream of an outside of a building near the user equipment, a video stream of an inside of a building near the user equipment, a layout or geographical map of a building near the user equipment, layout or a geographical map of an area surrounding the user equipment, historical data associated with previous movement of the user equipment, wireless fidelity information associated with the user equipment, global navigation satellite system measurements of the user equipment, radio access technology measurements of the user equipment, or a list of neighboring user equipment comprising identifiers of user equipment that are neighbors of the user equipment.

38. (canceled)

39. (canceled)

40. The second device of, wherein the computer program code comprises computer program code of a network data analytics function, and wherein the first request is received from a location management function of the first device.

41-46. (canceled)
